(19) United States
(12) Patent Application Publication
(10) Pub. No.: US 2026/0014808 A1
(43) Pub. Date: Jan. 15, 2026

(54) METHODS, SYSTEMS, AND APPARATUSES FOR PASSIVE RETENTION OF PRINTING SUBSTRATES ON A PRINTING BELT

(71) Applicant: ELECTRONICS FOR IMAGING, INC., Londonderry, NH (US)

(72) Inventor: Moris TEANI, Bergamo (IT)

(21) Appl. No.: 19/264,457

(22) Filed: Jul. 9, 2025

(30) Foreign Application Priority Data
Jul. 15, 2024 (IT) 102024000016384

(51) Int. Cl. B41J 11/00

(52) U.S. Cl. CPC B41J 11/007

(57) ABSTRACT

Methods, systems, and apparatuses for passively retaining a printing substrate on a printing conveyer belt are disclosed. In some embodiments, an adhesive apparatus is positioned on top of a printing conveyer belt. The apparatus adheres and/or couples to a printing substrate on a top surface and adheres and/or couples to the printing conveyer belt on a bottom surface. The apparatus is configured with a first plurality of adhesion elements on the top surface, which are configured to adhere to the substrate. In some embodiments, the bottom surface is configured to adhere and/or couple to the conveyer belt via a second plurality of adhesion elements. In some embodiments, the adhesion elements are concave discs and/or convex projections configured to provide a force to the substrate and/or conveyer belt (e.g., suction force, friction force, electrostatic force, Van der Waals force, etc.).

### CROSS-REFERENCE TO RELATED APPLICATIONS

This application claims priority to Italy Application No. 102024000016384 filed Jul. 15, 2024, the content of which is incorporated in its entirety.

### FIELD OF THE INVENTION

This description relates generally to inkjet and analog printing, and specifically about the conveying of substrates on a continuous belt machine.

### BACKGROUND

In most inkjet and analog printing processes, a substrate (e.g., fabric, cardboard, paper, tiles) is transported on a conveyer belt through a print area, in which ink or dye is deposited on the substrate. Conventional printing conveyer systems often use vacuum mechanisms or adhesives to couple the substrate to the conveyer belt. However, vacuum mechanisms are energy intensive, take up a lot of space, are noisy, induce a large amount of friction to the conveyer belt, and can introduce print defects. Adhesive solutions are generally not food grade compatible, not eco-friendly, are hard to remove, may damage certain substrates, and usually lose their retention properties over time. Thus, solutions are needed to overcome some of the defects of conventional conveyer belt systems.

### BRIEF DESCRIPTION OF THE DRAWINGS

FIG. 1 illustrates a perspective view of a printing system, in accordance with one or more embodiments.

FIG. 2 illustrates a side view of a printing system, including a printer head and a light/heat source, in accordance with one or more embodiments.

FIG. 3 illustrates a planar view of a passive retention system for continuous belt printing, in accordance with one or more embodiments.

FIGS. 4A-4H are illustrations of various examples of adhesion apparatuses and adhesion elements, in accordance with one or more embodiments.

FIG. 5 is a perspective illustration of a printing system, in accordance with one or more embodiments.

FIG. 6 is a flow diagram illustrating a method of operating a passive retention system, in accordance with one or more embodiments.

FIG. 7 is a block diagram illustrating a computer system, in accordance with one or more embodiments.

### DETAILED DESCRIPTION

Methods, systems, and apparatuses for passively retaining a printing substrate on a printing conveyer belt are disclosed. For example, in some embodiments, an adhesive apparatus (e.g., a layer, film, mat, etc.) is positioned on top of a printing conveyer belt. The apparatus adheres and/or couples to a printing substrate on a first side of the apparatus (e.g., a top surface of the apparatus), and adheres and/or couples to the printing conveyer belt on a second side of the apparatus (e.g., a bottom surface of the apparatus). The apparatus is configured with a first plurality of adhesion elements on the first side, which are configured to adhere to the substrate. The second side of the apparatus is configured to adhere and/or couple to the conveyer belt via a second plurality of adhesion elements. In some embodiments, the second side adheres and/or couples to the conveyer belt via an adhesive coating, such as glue or other bonding compound. When the substrate is adhered/coupled to the first side of the apparatus and the apparatus is adhered/coupled to the conveyer, the conveyer can transport the substrate to a printing area where the printing process proceeds (e.g., ink may be deposited on the substrate in the printing area). In some embodiments, the substrate is removed after reaching/passing through the printing area, and the section of the apparatus to which the substrate was coupled is washed and dried. The washed/dried section of the apparatus is thus prepared to receive another substrate and the conveying process is repeated.

In some embodiments, the adhesion elements are configured to provide one or more of a suction, friction, pressure, electrostatic charge, Van der Waals force, or additional force, to the substrate and/or conveyer belt. Thus, the adhesion elements are configured to couple the substrate and/or conveyer belt to the apparatus. In some embodiments, the adhesion elements can be concave discs (e.g., suction cups/micro cups) disposed on top of the adhesion apparatus and/or, in some embodiments recessed in the top surface of the adhesion apparatus. For the purposes of this application, the term “concave disc” refers to discs that curve inward toward a centerline of an adhesion apparatus, such that the tip of the curved shape is closest to the centerline of the apparatus. In some embodiments, the adhesion elements are convex projections (e.g., bumps/micro bumps). For the purposes of this application, the term “convex projection” refers to projections that curve outward from a centerline of an adhesion apparatus such that the tip of the curved shape is furthest from the centerline of the apparatus.

The advantages and benefits of the disclosed technology include providing a passive conveyer retention system that can firmly and effectively hold a printing substrate in place during printing without using noisy, energy-intensive vacuum mechanisms, or non-environmentally-friendly, non-food-compatible adhesive solutions. Unlike many conventional conveyer technologies, the disclosed technology can be used with a wide variety of substrates and inks without risk of damaging the substrates or introducing print defects due to vacuum effects on the ink. Further, the disclosed technology requires much less physical space (and machinery) than many conventional conveyer technologies, reducing the physical footprint of industrial printing processes.

Additionally, the disclosed technology can substantially reduce the electrical loading requirements of industrial-scale printing processes, reducing electrical loading on power plants and, ultimately, reducing greenhouse gas emissions emitted by power plants when compared to conventional vacuum mechanisms. Furthermore, the disclosed technology does not need to be replaced as frequently as some conventional conveyer solutions, mitigating material waste. In some embodiments, the disclosed technology includes washing and drying mechanisms for the adhesive apparatus, extending the apparatus's operational life, its retention effectiveness, and further reducing material waste.

These and other aspects, features, and implementations can be expressed as methods, apparatus, systems, components, program products, means or steps for performing a function, and in other ways. These and other aspects, features, and implementations will become apparent from the following descriptions, including the claims.

In the following description, for the purposes of explanation, numerous specific details are set forth in order to provide a thorough understanding of the present embodiments. It will be apparent, however, that the present embodiments may be practiced without these specific details.

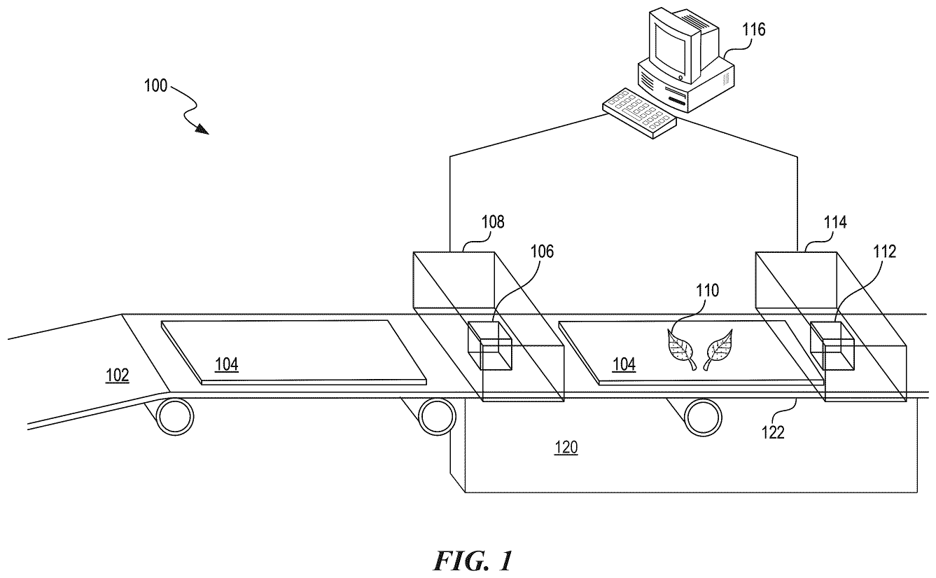

FIG. 1 illustrates a perspective view of a printing system 100, in accordance with one or more embodiments. The printing system 100 includes a printer head 106, at least one light and/or heat source 112, and a substrate transportation system 102. Embodiments may include various combinations of these and other components, e.g., a dryer. For example, the light/heat source 112 may be present in some embodiments, but not in others. As another example, a dryer or a fixation unit may be included if an image 110 will not be quickly transferred to a substrate. The substrate transportation system 102 can include a belt, actuators, pulleys, etc., to move the substrate. While the printing system 100 of FIG. 1 can include a transfer belt, other means for conveying and/or retaining a substrate or transfer material 104 can also be used, such as a rotating platform or stationary bed.

The printer head 106 is configured to deposit ink onto a substrate or the transfer material 104 in the form of an image 110. The transfer material 104, which may also be referred to as a former material, is flexible, which allows the image 110 to be transferred to complex-shaped substrates. For example, the transfer material 104 may be a rubber former, a thermoformable material, etc. In some embodiments, the printer head 106 is an inkjet printer head that jets ink onto the substrate or the transfer material 104 using, for example, piezoelectric nozzles. In some embodiments, the ink is a water-based energy curable ink or solvent-based energy curable ink. However, other inks may also be used, such as solid energy, e.g., UV-curable ink. The ink can be deposited in different forms, such as ink droplets and colored polyester ribbons.

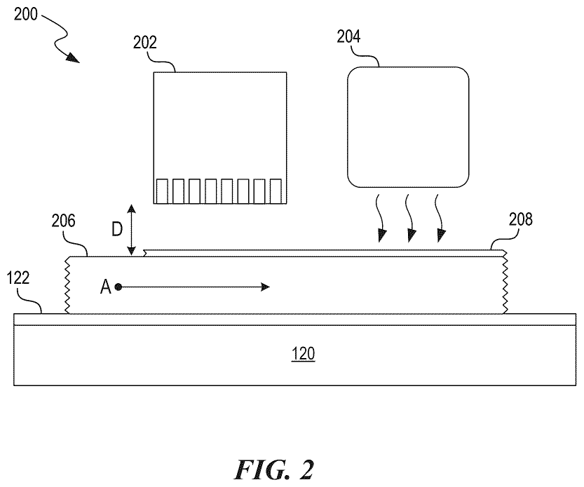

In some embodiments, one or more light and/or heat sources 112 cure some or all of the ink deposited onto the substrate or the transfer material 104, by emitting UV radiation, hot air, or by contact between transfer material 104 and a heating surface. The light/heat source(s) 112 may be, for example, a UV fluorescent bulb, a UV light emitting diode (LED), a low-pressure, e.g., mercury (Hg) bulb, an excited dimer (excimer) lamp and/or laser, a hot air source, and/or an infrared (IR) lamp. Various combinations of these and other light/heat sources could be used. For example, a printing system 100 may include a low-pressure Hg lamp and a UV LED. As discussed in more detail with reference to FIG. 2, the light/heat source 112 may be configured to emit UV radiation of a particular subtype.

The printer head 106 and light/heat source 112 are illustrated as being directly adjacent to one another, i.e., neighboring without any intervening components. However, additional components that assist in printing, curing, etc., may also be present. For example, multiple distinct light/heat sources 112 may be positioned behind the printer head 106. FIG. 1 illustrates one possible order in which components may be arranged in order to print an image 110 onto the substrate or the transfer material 104. Other embodiments are considered in which additional components are placed before, between, or after the illustrated components, etc.

In some embodiments, one or more of the aforementioned components are housed within one or more carriages. For example, the printer head 106 can be housed within a printing carriage 108, the light/heat source 112 can be housed within a curing carriage/frame/body 114, etc. In addition to protecting the components from damage, the carriages/frame/body 114 may also serve other benefits. For example, the curing carriage/frame/body 114 can limit what portion(s) of the transfer material 104 and image 110 are exposed during the curing process. The printing system 100 may include pulleys, motors, rails, and/or any combination of mechanical or electrical technologies that enable the carriages/frames/bodies to travel along the substrate transportation system (e.g., the transfer belt 102), i.e., with respect to the substrate or the transfer material 104. The transfer belt 102 is affixed to a vacuum table 120 and moves over a vacuum platen 122 that is on top of the vacuum table 120. In alternative embodiments, the carriages can be fixedly attached to a rail or base of the printing system 100. In these embodiments, the transfer material 104 can be moved in relation to the printer head 106, light/heat source 112, etc., such that ink can be deposited onto the transfer material 104.

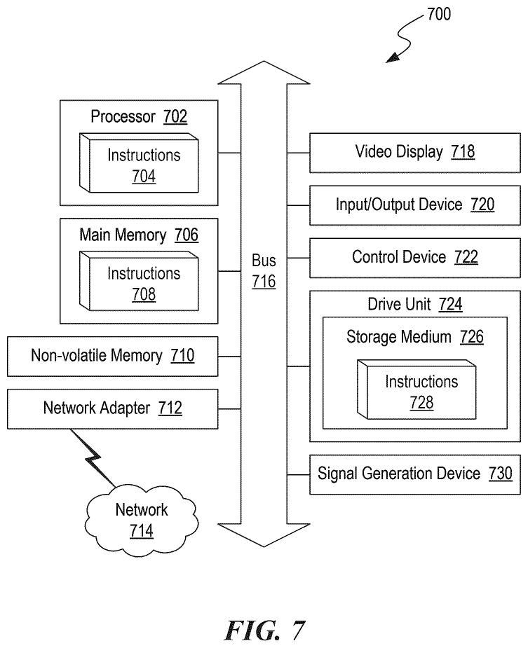

In various embodiments, some or all of the components are controlled by a computer system 116. The computer system 116 is the same as or similar to the computer system 700 illustrated and described in more detail with reference to FIG. 7. The computer system 116 can allow a user to input printing instructions and information, modify print settings, e.g., by changing cure settings, alter the printing process, etc.

FIG. 2 illustrates a side view of a printing system 200, including a printer head 202 and a light/heat source 204, in accordance with one or more embodiments. While a single-pass configuration is illustrated by FIG. 2, other embodiments may employ multi-pass, i.e., scan, configurations. Similarly, embodiments can be modified for various printers, e.g., flatbed printer, drum printer, or lane printer. For example, a flatbed printer may include a stable bed and a traversing printer head, a stable printer head and a traversing bed, etc. A substrate transportation system is affixed to a vacuum table 120 and moves over a vacuum platen 122 that is on top of the vacuum table 120.

The printer head 202 can include distinct ink/color drums, e.g., cyan, magenta, yellow, and black (CMYK), or colored polyester ribbons that are deposited onto the surface of a transfer material 206. Path A represents the media feed direction, e.g., the direction in which the substrate or the transfer material 206 travels during the printing process. Path D represents the distance between the printer head 202 and the surface of the transfer material 206.

As described above, both direct and indirect printing have conventionally been carried out only on flat surfaces. The printing systems and methods described herein, however, allow images to be printed on complex-shaped, i.e., non-planar, surfaces by depositing ink directly onto a substrate or a transfer material 206 and then transferring the ink to a subsequent substrate. When printing directly onto a surface, print quality relies on accuracy of ink drop placement. Therefore, maintaining a constant or nearly constant distance between the printer head 202 and the flat surface of the transfer material 206 is necessary. Airflow, velocity variability, etc., can affect drop placement even when the change in distance is small, e.g., a few millimeters.

In some embodiments, a light/heat source 204 cures some or all of the ink 208 deposited onto the substrate or the transfer material 206 by the printer head 202. The light/heat source 204 may be configured to emit wavelengths of UV electromagnetic radiation of subtype V (UVV), subtype A (UVA), subtype B (UVB), subtype C (UVC), or any combination thereof. Generally, UVV wavelengths are those wavelengths measured between 395 nanometers (nm) and 445 nm, UVA wavelengths measure between 315 nm and 395 nm, UVB wavelengths measure between 280 nm and 315 nm, and UVC wavelengths measure between 100 nm and 280 nm. However, one skilled in the art will recognize these ranges are somewhat adjustable. For example, some embodiments may characterize wavelengths of 285 nm as UVC.

The light/heat source 204 may be, for example, a fluorescent bulb, a light emitting diode (LED), a low-pressure, e.g., mercury (Hg) bulb, an excited dimer (excimer) lamp/laser, a hot air source, and/or an infrared (IR) lamp. Combinations of different light/heat sources could be used in some embodiments. Generally, the light/heat source 204 is selected to ensure that the curing temperature does not exceed the temperature at which the ink 208 begins to sublime. For example, light/heat source 204 of FIG. 2 can be a UV LED lamp that generates low heat output and can be used for a wider range of former types. UV LED lamps are associated with lower power consumption, longer lifetimes, and more predictable power output.

Other curing processes may also be used, such as epoxy (resin) chemistries, flash curing, and electron beam technology. One skilled in the art will appreciate that many different curing processes could be adopted that utilize specific timeframes, intensities, rates, etc. The intensity may increase or decrease linearly or non-linearly, e.g., exponentially, logarithmically. In some embodiments, the intensity may be altered using a variable resistor or alternatively by applying a pulse-width-modulated (PWM) signal to the diodes in the case of an LED light source.

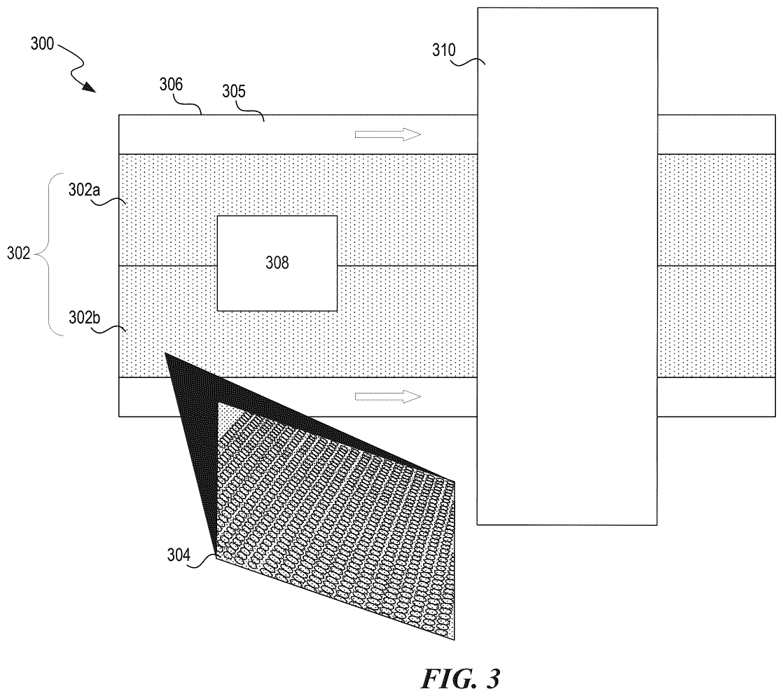

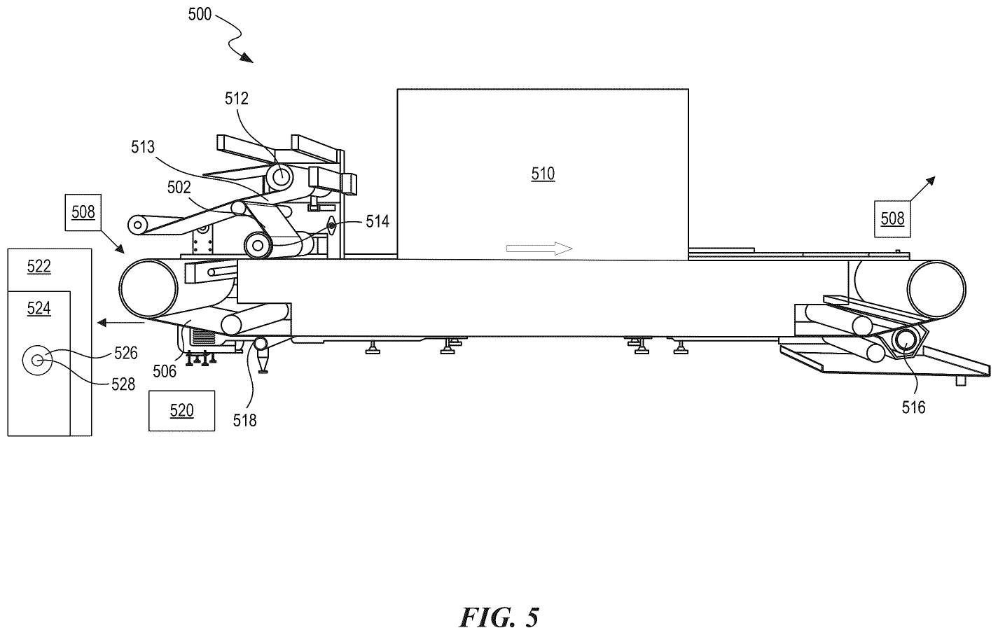

FIG. 3 illustrates a planar view of a passive retention system 300 for continuous belt printing, in accordance with one or more embodiments. In some embodiments, the passive retention system 300 includes the printing system 100 of FIG. 1, the printing system 200 of FIG. 2, and/or the printing system 500 of FIG. 5.

The passive retention system 300 is comprised of an adhesion apparatus 302 (e.g., an adhesion layer, film, mat, sheet) configured with a plurality of adhesion elements 304 on a top surface (e.g., a first surface). A bottom surface (e.g. a second surface) of the adhesion apparatus 302 is configured to couple to a top surface 305 of a printing conveyer belt 306 such that the adhesion apparatus 302 is positioned on top of the conveyer belt 306. The conveyer belt 306 is configured to transport a printing substrate 308 to a print area 310 as part of a printing process (e.g., the substrate 308 can receive ink at the print area 310). In some embodiments, the adhesion apparatus 302 is further comprised of a plurality of adhesion subsections 302a, 302b. Each of the subsections 302a, 302b are configured with a plurality of adhesions elements 304. In some embodiments, the adhesion apparatus 302 is integrated with the conveyer belt 306 such that the top surface 305 of the conveyer belt 306 is comprised of the adhesion apparatus 302.

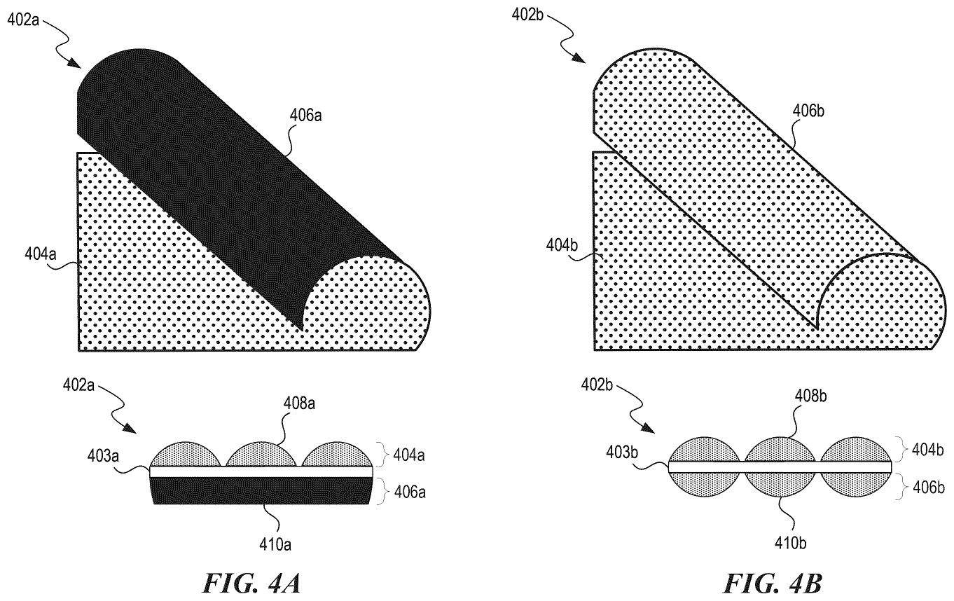

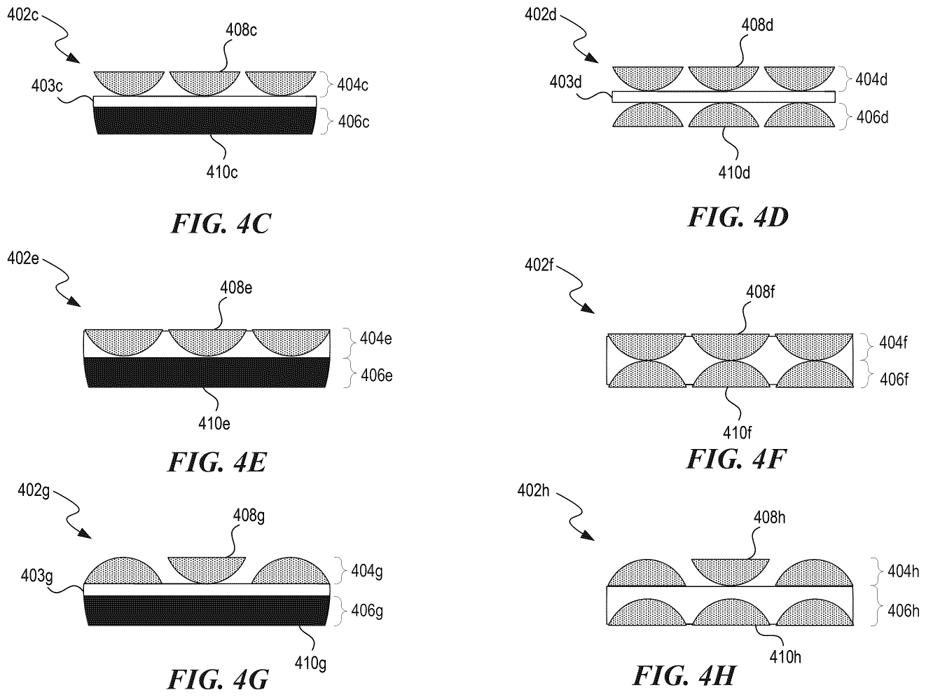

The plurality of adhesion elements 304 are configured to couple (e.g., adhere, hold, attach, fix) the substrate 308 to the top surface of the adhesion apparatus 302. As discussed in greater detail in FIGS. 4A-4H, the plurality of adhesion elements 304 are configured to passively adhere the substrate 308 to the adhesion apparatus 302 via one or more of a suction, friction, pressure, electrostatic charge, Van der Waals force, and/or other passive coupling mechanism. Put another way, the plurality of adhesion elements 304 are configured to hold the substrate 308 firmly in place without an external source of energy or moving parts required to maintain and/or generate the adhering force/mechanism between the substrate 308 and the adhesion elements 304, as the conveyer belt 306 transports the substrate 308 to the printing area 310.

FIGS. 4A-4H are illustrations of various examples of adhesion apparatuses and adhesion elements, in accordance with one or more embodiments. FIG. 4A shows an adhesion apparatus 402a with a plurality of adhesion elements 408a on a single side 404a of the apparatus 402a. For example, in some embodiments, the plurality of adhesion elements 408a are comprised of convex projections forming and/or positioned on at least a portion of a top side 404a of the apparatus 402a. The convex projections are configured to couple with a printing substrate by providing one or more of a suction, friction, pressure, electrostatic charge, Van der Waals force, and other coupling mechanism to the substrate.

A bottom side 406a is configured to couple with a conveyer belt. In some embodiments, an adhesive coating 410a (e.g., glue or other bonding compound) is applied to and/or forms the bottom side 406a. The adhesive coating 410a is configured to hold and/or couple the adhesion apparatus 402a to the conveyer belt.

In some embodiments, adhesion apparatus 402a includes an intermediate layer 403a that provides a boundary separating the top side 404a from the bottom side 406a. The intermediate layer 403a also physically supports the plurality of adhesion elements 408a and provides a surface on which the adhesive coating 410a is applied. In some embodiments, the intermediate layer 403a is omitted from the apparatus 402a and a top part of bottom side 406a directly contacts and/or supports a bottom part of top side 404a.

FIG. 4B shows an adhesion apparatus 402b with multiple pluralities of adhesion elements 408b and 410b on two sides 404b and 406b. Similar to the adhesion elements of FIG. 4A, in some embodiments, the multiple pluralities of adhesion elements 408b and 410b are comprised of convex projections. For example, the apparatus 402b is comprised of a first plurality of convex projections 408b forming/positioned on at least a portion of the top side 404b, and a second plurality of convex projections 410b forming/positioned on at least a portion of a bottom side 406b opposite the top side 404b. The first plurality of convex projections 408b is configured to adhere the adhesion apparatus 402b to a printing substrate. The second plurality of convex projections 410b is configured to adhere the adhesion apparatus 402b to a printing conveyer belt. The first and second pluralities of convex projections are configured to adhere the apparatus 402b to the printing substrate and conveyer belt by providing one or more of a suction, friction, pressure, electrostatic charge, Van der Waals force, and other coupling mechanism. In some embodiments, adhesion apparatus 402b includes an intermediate layer 403b that separates the top side 404b from the bottom side 406b and physically supports the first and second pluralities of adhesion elements 408b and 410b. In some embodiments, intermediate layer 403b is omitted and the top and bottom sides 404b and 406b directly contact each other.

FIG. 4C shows an adhesion apparatus 402c with a plurality of adhesion elements 408c forming/positioned on at least a portion of a first side 404c of the apparatus 402c. Each of the components shown in FIG. 4C are the same as or are generally similar to the corresponding components described in connection with adhesion apparatus 402a with reference to FIG. 4A, with the exception that the adhesion elements 408c are comprised of concave discs.

FIG. 4D shows an adhesion apparatus 402d with multiple pluralities of adhesion elements 408d and 410d forming/positioned on at least a portion of a first side 404d (e.g., a first plurality of adhesion elements 408d) and at least a portion of a second side 406d (e.g., a second plurality of adhesion elements 410d) of the apparatus 402d. Each of the components shown in FIG. 4D are the same as or are generally similar to the corresponding components described in connection with adhesion apparatus 402b with reference to FIG. 4B, with the exception that the multiple pluralities of adhesion elements 408d and 410d are comprised of concave discs.

FIG. 4E shows an adhesion apparatus 402e with a plurality of adhesion elements 408e forming/positioned on at least a portion of a first side 404e of apparatus 402e. Each of the components shown in FIG. 4E are the same as or are generally similar to the corresponding components described in connection with adhesion apparatus 402c with reference to FIG. 4C, with the exception that the adhesion elements 408c are recessed in at least a portion of the first side 404e, and the intermediate layer has been omitted from the apparatus 402e such that the first side 404e and a second side 406e are in contact with each other.

FIG. 4F shows an adhesion apparatus 402f with multiple pluralities of adhesion elements 408f and 410f, each of which is recessed in a respective side of the adhesion apparatus 402f. For example, a first plurality of adhesion elements 408f is recessed in a first side 404f, and a second plurality of adhesion elements 410f is recessed in a second side 406f. Each of the components shown in FIG. 4F are the same as or are generally similar to the corresponding components described in connection with adhesion apparatus 402d with reference to FIG. 4D, with the exception that the first and second pluralities of adhesion elements 408f and 410f are recessed in the first and second sides 404f and 406f, and the apparatus 402f does not comprise an intermediate layer.

FIG. 4G shows an adhesion apparatus 402g with a plurality of adhesion elements 408g forming/positioned on at least a portion of a first side 404g of the apparatus 402g. Each of the components shown in FIG. 4G are the same as or are generally similar to the corresponding components described in connection with adhesion apparatus 402a with reference to FIG. 4A, with the exception that the adhesion elements 408g are comprised of a mix of convex projections and concave discs.

FIG. 4H shows an adhesion apparatus 402h with multiple pluralities of adhesion elements 408h and 410h. A first plurality of the adhesion elements 408h forms/is positioned on at least a portion of a first side 404h of the apparatus 402h, and is comprised of a mix of concave discs and convex projections. A second plurality of the adhesion elements 410h is recessed in a second side 406h of the apparatus 402h and is comprised of concave discs. In some embodiments, one or more pluralities of the first and second pluralities of adhesion elements 408h and 410h are stand-alone components fixed to the adhesion apparatus 402h. In some embodiments, the sides/surface of the adhesion apparatus 402h are shaped such that the first and second pluralities of adhesion elements 408h and 410h are formed in the sides/surfaces of the adhesion apparatus. In the embodiment shown in FIG. 4H, an intermediate layer is omitted from the apparatus 402h. Aside from the differences noted above, each of the components shown in FIG. 4H are the same as or are generally similar to the corresponding components described in connection with adhesion apparatus 402f with reference to FIG. 4F.

FIG. 5 is a perspective illustration of a printing system 500, in accordance with one or more embodiments. In some embodiments, the printing system 500 is the same or is generally similar to the printing system 100 of FIG. 1, and the printing system 200 of FIG. 2. In some embodiments, a passive retention system, such as the passive retention system 300 of FIG. 3, is comprised of the printing system 500.

Printing system 500 includes an adhesion apparatus 502 configured with one or more pluralities of adhesion elements. The adhesion apparatus 502 is positioned on a top surface of a printing conveyer belt 506. In some embodiments, the adhesion apparatus 502 is the same or is generally similar to the adhesion apparatus 302 described in FIG. 3, and/or the adhesion apparatuses 402a-h described in FIGS. 4A-4H. In some embodiments, the printing system 500 includes a film removing component 512 configured to remove a packaging film 513 from the adhesion apparatus 502. The packaging film 513 is removed prior to the adhesion apparatus 502 being positioned on the conveyer belt 506. In some embodiments, the printing system 500 includes a pressing component 514 (e.g., a presser) configured to assist in coupling a bottom side of the adhesion apparatus 502 to the top surface of the conveyer belt 506. For example, the pressing component 514 can apply pressure to the adhesion apparatus 502 and the conveyer belt 506, causing the bottom surface of the adhesion apparatus 502 to adhere or couple to the conveyer belt 506.

The conveyer belt 506 is configured to transport a substrate 508 to and/or through a printing area 510 via adhering the substrate 508 to the adhesion apparatus 502 and transporting the adhered substrate 508. In some embodiments, a second pressing component (not pictured) assists in adhering the substrate 508 to the adhesion apparatus 502 by applying a pressure between the substrate 508 and the top side of the adhesion apparatus 502. In some embodiments, the same pressing component 514 is used to both apply the adhesion apparatus 502 to the conveyer belt 506, and to apply the substrate 508 to the adhesion apparatus 502. In some embodiments, after reaching and/or passing through the printing area 510, the substrate 508 is removed from the adhesion apparatus 502, and the conveyer belt 506 transports the adhesion apparatus 502 through a washing stage 516 and drying stage 518 before returning the adhesion apparatus 502 to receive additional substrates 508.

In some embodiments the washing stage 516 is comprised of a washing component configured to wash the adhesion apparatus 502. For example, the washing component can comprise a rotating brush with a fluid (e.g., water) applied to the brush, where the rotation of the brush causes the bristles of the brush to skim the top surface of the adhesion apparatus 502 to remove dirt, dust, ink, etc.

In some embodiments, the drying stage 518 is comprised of a drying component configured to dry the adhesion apparatus 502. For example, the drying component can comprise an air blower/suction and/or wiping mechanism configured to remove water residue from the adhesion apparatus 502 after the adhesion apparatus 502 is washed at the washing stage 516.

In some embodiments, the adhesion apparatus 502 is removed from the conveyer belt 506 following removal of the substrate 508. In some embodiments, the adhesion apparatus 502 is removed from the conveyer belt 506 after passing through the washing stage 516 and/or drying stage 518. In some embodiments, the adhesion apparatus 502 is removed from the conveyer belt 506 because the adhesion apparatus 502 loses retention/adhesion properties of one or more of its sides (e.g., the top side configured to couple to the substrate 508, and/or the bottom side configured to couple to the conveyer belt 506). The adhesion apparatus 502 is removed after exposure to a heat source 520 (e.g., an IR lamp), where the heat source 520 is configured to weaken the attachment/fixation/adhesion force between the adhesion apparatus 502 and the conveyer belt 506. The heat source 520 is positioned near a removal component 522 configured to fix/attach/adhere to a surface of the adhesion apparatus 502, and to rotate in a direction opposite the movement path of the conveyer belt 506, thus pulling the adhesion apparatus 502 from the belt 506. In some embodiments, the removal component 522 is comprised of a gear motor 524 configured to drive an expandable bar 526 to rotate in the opposite direction of the conveyer belt 506. The adhesion apparatus 502 is attached to the expandable bar 526, and rotation of the expandable bar 526 results in the adhesion apparatus 502 pulling off of the conveyer belt 506. In some embodiments, the expandable bar 526 includes a cardboard component 528 detachably coupled to the expandable bar 526. The cardboard component 528 attaches to the adhesion apparatus 502, and rotation of the expandable bar 526 rotates the cardboard component 528, which pulls the adhesion apparatus 502 from the conveyer belt 506.

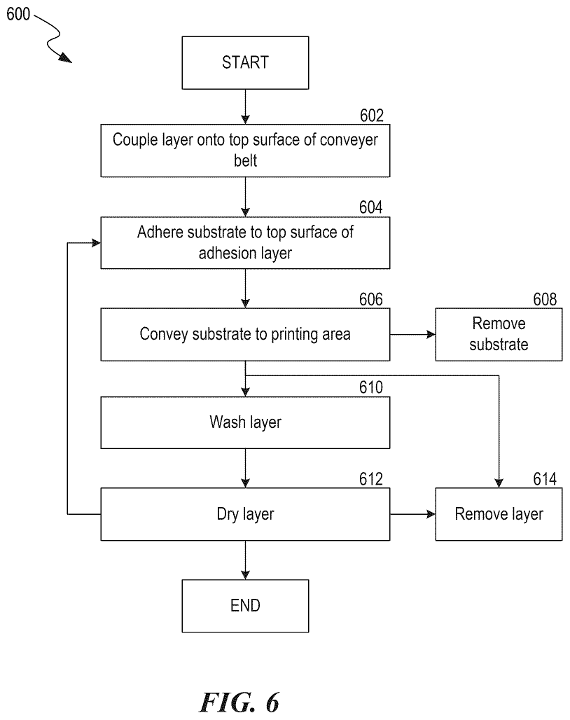

FIG. 6 is a flow diagram illustrating a method 600 of operating a passive retention system, in accordance with one or more embodiments. In some embodiments the passive retention system is the same or generally similar to the passive retention system 300 described with reference to FIG. 3. In some embodiments, the passive retention system includes one or more of the printing systems 100 of FIG. 1, 200 of FIG. 2, and 500 of FIG. 5. In some embodiments, one or more of the steps can be performed, at least in part, by a computer system, such as the computer system 700 of FIG. 7.

At block 602, a bottom surface of an adhesion layer (e.g., an adhesion apparatus as described in FIGS. 3-5) is coupled to the top surface of a printing conveyer belt. The bottom surface of the adhesion layer includes an adhesive component, such as a plurality of adhesive elements (e.g., concave discs and/or convex projections), or an adhesive compound (e.g., glue, bonding agent, etc.) which couples the adhesion layer to the conveyer belt. In some embodiments, a pressing component applies a pressure between the conveyer belt and the adhesion layer, causing the belt and the layer to couple.

At block 604 a substrate is adhered to a top surface of the adhesion layer via a plurality of adhesion elements positioned on and/or formed in the top surface of the layer. The top surface of the adhesion layer is opposite the bottom surface of the adhesion layer. The plurality of adhesion elements on the top surface of the adhesion layer are comprised of convex projections, concave discs, a mix, and/or additional adhesive structures. The adhesion elements are configured to provide a suction, friction, pressure, electrostatic charge, Van der Waals force, or other coupling mechanism to the substrate.

At block 606 the substrate is conveyed to a printing area via the movement of the conveyer belt. Since the substrate is coupled to the adhesion layer and the adhesion layer is coupled to the conveyer belt, the substrate is held in its relative place on the adhesion layer as the conveyer transports the adhesion layer and substrate. At block 608, the substrate is removed from the top surface of the adhesion layer. The adhesion layer is subsequently transported to and/or through a washing stage and a drying stage. At block 610 the adhesion layer is washed at the washing stage. The washing stage includes a washing component configured to wash the adhesion layer (e.g., a rotating brush with wetted bristles configured to remove dirt, debris, ink, etc.). At block 612 the adhesion layer is dried at the drying stage. The drying stage includes a drying component, such as a wiping mechanism and/or air blower/suction configured to remove washing fluid reside from the adhesion layer. Once the adhesion layer has been washed and dried, the adhesion layer is ready to receive additional substrates.

At block 614, in some embodiments, the adhesion layer is removed from the conveyer belt following removal of the substrate (e.g., at block 608). In some embodiments, the adhesion layer is removed following a washing stage (e.g., block 610) and/or a drying stage (e.g., block 612). Removal of the adhesion layer includes exposing the adhesion layer to a heat source (e.g., an IR lamp). The heat source heats the adhesion elements coupling the adhesion layer to the conveyer belt. In some embodiments, as the adhesion elements heat up, the adhering force between the adhesion elements and the conveyer belt weakens. The adhesion layer is attached to a removal component configured to remove the adhesion layer from the conveyer belt. In some embodiments, the removal component is comprised of a gear motor attached to a bar configured to expand from the gear motor (e.g., a collapsible bar). The bar includes a cardboard component (e.g., a cardboard tube or roll fitted over the bar) configured to receive the adhesion layer from the conveyer belt. The gear motor is configured to rotate the bar in a direction opposite the direction of motion of the conveyer belt. Once the adhesion layer is coupled to the cardboard component, gear motor rotates the bar, which rotates the cardboard component. Thus, the adhesion layer is pulled off of the conveyer belt. In some embodiments, the cardboard component is detachably couplable to the bar such that it can be removed from the bar after removing the adhesion layer.

FIG. 7 is a block diagram illustrating a computer system 700, in accordance with one or more embodiments. Components of the example computer system 700 can be used to implement the systems 100, 200, 300, and 500 illustrated and described in more detail with reference to FIGS. 1, 2, 3, and 5. At least some operations described with reference to FIG. 6 can be implemented on the computer system 700. Likewise, other embodiments include different and/or additional components, or be connected in a different way.

The computer system 700 can include one or more central processing units (“processors”) 702, main memory 706, non-volatile memory 710, network adapter 712 (e.g., network interface), video display 718, input/output devices 720, control device 722 (e.g., keyboard and pointing devices), drive unit 724 including a storage medium 726, and a signal generation device 730 that are communicatively connected to a bus 716. The bus 716 is illustrated as an abstraction that represents one or more physical buses and/or point-to-point connections that are connected by appropriate bridges, adapters, or controllers. The bus 716, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”).

The computer system 700 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality system (e.g., a head-mounted display), or another electronic device capable of executing a set of instructions (sequential or otherwise) that specify action(s) to be taken by the computer system 700.

While the main memory 706, non-volatile memory 710, and storage medium 726 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 728. The term “machine-readable medium” and “storage medium” shall also be taken to include any medium that is capable of storing, encoding, or carrying a set of instructions for execution by the computer system 700.

In general, the routines executed to implement the embodiments of the disclosure may be implemented as part of an operating system or a specific application, component, program, object, module, or sequence of instructions (collectively referred to as “computer programs”). The computer programs typically include one or more instructions (e.g., instructions 704, 708, 728) set at various times in various memory and storage devices in a computing device. When read and executed by the one or more processors 702, the instruction(s) cause the computer system 700 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 710, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 712 enables the computer system 700 to mediate data in a network 714 with an entity that is external to the computer system 700 through any communication protocol supported by the computer system 700 and the external entity. The network adapter 712 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 712 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, but no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications may be implemented by those skilled in the art.

What is claimed is:

1. A printing conveyer system comprising:
a conveyer belt configured to transport a substrate to a printing area; and
a layer positioned on a top surface of the conveyer belt, the layer including:
a first surface including a first plurality of adhesion elements, the first plurality of adhesion elements configured to couple the first surface to the substrate; and
a second surface opposite the first surface, the second surface configured to couple the layer to the top surface of the conveyer belt;
wherein the substrate is transported to the printing area by the conveyer belt when the substrate is coupled to the first surface of the layer.

2. The system of claim 1, wherein the first plurality of adhesion elements are concave discs.

3. The system of claim 1, wherein the first plurality of adhesion elements are convex projections.

4. The system of claim 1, wherein the first plurality of adhesion elements are configured to couple the first surface to the substrate through one or more of: a suction, a friction, a pressure, an electrostatic charge, and a Van der Waals force.

5. The system of claim 1, wherein the second surface includes a second plurality of adhesion elements, the second plurality of adhesion elements configured to couple the layer to the top surface of the conveyer belt.

6. The system of claim 1, wherein the second surface includes an adhesive coating, the adhesive coating configured to couple the layer to the top surface of the conveyer belt.

7. The system of claim 1 further comprising:
a pressing component configured to position the layer on the top surface of the conveyer belt such that the layer is coupled to the top surface of the conveyer belt;
a washing component to wash the layer;
a drying component configured to dry the layer; and
a removal component configured to remove the layer from the conveyer belt.

8. A system comprising:
a conveyer belt configured to transport a substrate; and
an adhesive apparatus disposed on the conveyer belt, the apparatus including:
a first side configured to adhere the substrate to the adhesive apparatus via a first plurality of adhesion elements; and
a second side configured to adhere the adhesive apparatus to the conveyer belt;
wherein the substrate is transported to a printing area by the conveyer belt when the substrate is adhered to the first side of the adhesive apparatus.

9. The system of claim 8, wherein the first plurality of adhesion elements are concave discs.

10. The system of claim 8, wherein the first plurality of adhesion elements are convex projections.

11. The system of claim 8, wherein the first plurality of adhesion elements are configured to couple the substrate to the adhesive apparatus through one or more of: a suction, a friction, a pressure, an electrostatic charge, and a Van der Waals force.

12. The system of claim 8, wherein the second side is configured to adhere the adhesive apparatus to the conveyer belt via a second plurality of adhesion elements.

13. The system of claim 8, wherein the second side is configured to adhere the adhesive apparatus to the conveyer belt via an adhesive coating.

14. The system of claim 8 further comprising:
a pressing component configured to position the adhesive apparatus on the conveyer belt such that the adhesive apparatus is adhered to the conveyer belt;
a washing component configured to wash the adhesive apparatus;
a drying component configured to dry the adhesive apparatus; and
a removal component configured to remove the adhesive apparatus from the conveyer belt.

15. A method of conveying a printing substrate, the method comprising:
coupling a layer onto a top surface of a conveyer belt, the layer including a first surface and a second surface opposite the first surface, wherein the second surface couples the layer to the top surface of the conveyer belt;
adhering a substrate to the first surface of the layer via a first plurality of adhesion elements of the first surface; and
conveying the substrate to a printing area.

16. The method of claim 15 further comprising:
removing the substrate from the first surface of the layer;
transporting the layer to a washing component configured to wash the layer;
transporting the layer to a drying component configured to dry the layer;
heating the layer via a heating source; and
removing the layer from the top surface of the conveyer belt via a removal component configured to pull the layer off of the conveyer belt.

17. The method of claim 15, wherein the first plurality of adhesion elements are concave discs, and wherein adhering the substrate to the first surface of the layer further includes providing one or more of: a suction, a friction, a pressure, an electrostatic charge, and a Van der Waals force to the substrate via the first plurality of adhesion elements.

18. The method of claim 15, wherein the first plurality of adhesion elements are convex projections, and wherein adhering the substrate to the first surface of the layer further includes providing one or more of: a suction, a friction, a pressure, an electrostatic charge, and a Van der Waals force to the substrate via the first plurality of adhesion elements.

19. The method of claim 15, wherein coupling the layer onto the top surface of the conveyer belt further includes a second plurality of adhesion elements of the second surface, the layer coupled to the top surface of the conveyer belt via the second plurality of adhesion elements.

20. The method of claim 15, wherein coupling the layer onto the top surface of the conveyer belt further includes an adhesive coating of the second surface, the layer coupled to the top surface of the conveyer belt via the adhesive coating.
